(19) United States
(12) Patent Application Publication
(10) Pub. No.: US 2003/0169889 A1
(43) Pub. Date: Sep. 11, 2003

(54) Spa audio system

(76) Inventor: Steve Macey, Oceanside, CA (US)

Correspondence Address: Albin H. Gess, Snell & Wilmer L.L.P., Suite 1200, 1920 Main Street, Irvine, CA, 92614-7230, US

(21) Appl. No.: 10/364,080

(22) Filed: Feb. 11, 2003

Related U.S. Application Data
(63) Continuation of application No. 09/516,132, filed on Mar. 1, 2000, now Pat. No. 6,556,684.

(51) Int. Cl. H04R 1/02

(52) U.S. Cl. 381/89

(57) ABSTRACT

A portable spa including an audio system designed to use the spa shell as the sound generating device. Transducer devices are mounted within an enclosure which is bonded to the spa shell so as couple the sound vibration energy to the shell so that sound can be heard when using the spa.

### CROSS-REFERENCE TO RELATED APPLICATIONS

This application is a continuation of application Ser. No. 09/516,132 filed Mar. 1, 2000 for Spa Audio System.

### BACKGROUND OF THE INVENTION

1. Field of the Invention

The subject invention relates generally to spas and more particularly to an audio system utilizing a spa shell as a sound-generating device.

2. Description of Related Art

Existing spa audio systems use traditional speakers wherein the audio drivers are exposed to the harsh spa environment and/or require protection or esoteric materials to prevent premature failure. Existing spa audio systems also suffer from the limited space available to mount speakers. The resultant smaller speakers are incapable of producing full range audio (50 Hz-17 kHz).

### SUMMARY OF THE INVENTION

According to the invention, a spa shell is employed as an audio driver with audio transducers mounted inside the skirt of the spa. The inventor has found that the spa shell provides both sufficient rigidity for high frequency reproduction and a sufficiently large surface area to achieve low frequency reproduction.

### BRIEF DESCRIPTION OF THE DRAWINGS

The just summarized invention will now be described in detail in conjunction with the drawings of which:

FIG. 1 is a schematic cross-sectional diagram illustrating a spa audio system according to the preferred embodiment;

FIG. 2 illustrates an enclosure apparatus for attaching transducers to the spa shell; and

FIG. 3 is a schematic diagram of an alternate embodiment employing an RF transmitting device.

### DETAILED DESCRIPTION OF THE PREFERRED EMBODIMENTS

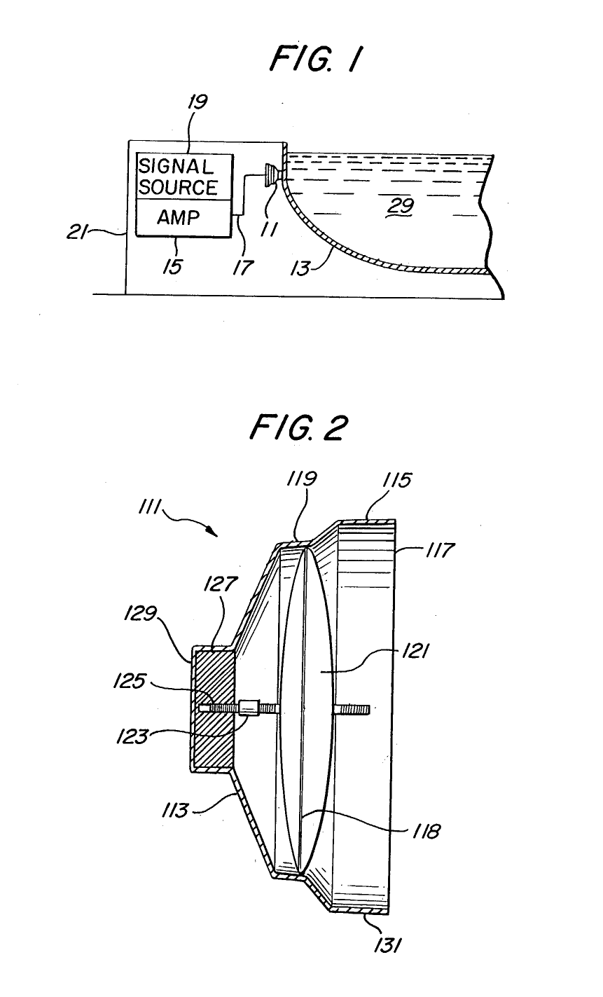

FIG. 1 illustrates a spa audio system according to a preferred embodiment. According to this embodiment, audio transducer devices 11 are bonded to a spa shell 13. The transducer devices 11 couple the second vibration energy so that sound can be heard when using the spa. Two transducer devices 11 are preferably provided for stereo effect but one device or more than two devices may also be used. The transducer devices II may be driven by a conventional integrated audio amplifier 15, providing, e.g., 100-300 watts per channel.

The spa shell 13 is rigid enough to support the weight of water and bathers but is sufficiently compliant to reproduce full range audio. A typical spa shell 13 is formed of thermoset plastic or thermoplastic and has a thickness of 0.100-0.300 inches. Of course, other materials and dimensions providing the functional prerequisites for water/bather support and audio transmission may be employed.

Rigid engagement of each transducer device 11 to the spa shell 13 is required. The installation method preferably prevents spa insulation material from contaminating the transducer/shell coupling. This is achieved by constructing the transducer device 11 as a formed enclosure that surrounds a transducer element and installing it to the spa shell 13 before the insulation material is applied. A suitable audio transducer element is Model TST 329 as available from Clark Synthesis, Inc., 8122 S. Park Lane, Littleton, Colo. 80120.

An illustrative formed enclosure 111 is shown in FIG. 2. This enclosure 111 includes a thermoformed molded plastic housing 113, which may be fabricated, for example, from ⅛″ ABS plastic. The housing 113 includes an outer cylindrical shell portion 115, which provides a circular rim or edge 117, which is open.

Adjacent the open rim 117 of the enclosure 111, a somewhat smaller concentric cylindrical portion 119 is provided, which is of a diameter selected to support the outer rim 118 of the transducer element 121. A nut 123 is threaded onto a threaded projection of the transducer 121 and receives a threaded end of a stud 125. The stud 125 threads into a cylindrical plug or puck 127 formed of plastic or metal at a closed end 129 of the housing 113, thereby attaching and further supporting the transducer 121 within the housing 113.

Attachment of the housing 113 and the cylindrical puck 127 to the spa shell 13 is preferably provided by gluing the end 129 of the housing 113 to the shell 13 (FIG. 1) foam could also (??) be used. The puck 127 is then glued to the inside of the housing 113 at the closed end 129.

Additionally, support to the lower end 131 of the housing 113 may be provided, for example, via a brace attached to the spa frame structure at the lower end 131 of the housing in order to relieve any shear stress created by hanging the housing/transducer assembly off the side of the spa shell 13. A hatch or door in the spa skirt 21 (FIG. 1) may also be provided to access the speaker enclosures 111 through the open ended rim 117 of housing 113.

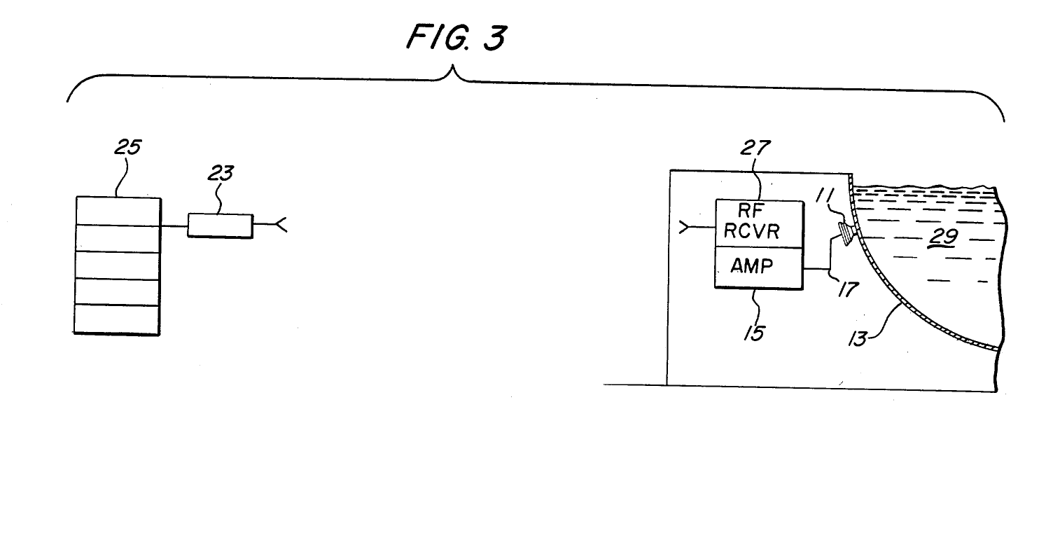

The output signal of the amplifier 15 may be coupled to the transducers via conventional speaker wire 17. In such case, the amplifier 15 and audio components 19 supplying it, such as preamplifiers and/or CD players, may be located in a compartment within the spa skirt 21 or elsewhere. Alternatively, as shown in FIG. 3, a remote transmitting device 23 (e.g., RF) may be used to enable use of a homeowner's home audio system 25 as the music signal source. Such remote transmitting devices are commercially available, for example, the 900 MHz or 2.4 GHz wireless receiver/transmitters provided by X-10 USA, Closter, N.J. 07624. In such case, a receiver 27 located at the spa provides the home audio signal to the amplifier 15, which then drives the transducers 11.

In operation, the audio can be heard under water 29 as well as above the water 29. Listeners outside the spa can also hear the audio signal, but the experience is muted compared to that of the tub occupant.

As may be appreciated, the preferred embodiment permits the audio transducer devices to be enclosed within the spa, providing improved aesthetics by eliminating exposed speaker locations. Enclosing the transducer devices within the spa also protects them from water and reduces the risk of water exposure to electrical signals.

From the above description, those skilled in the art will appreciate that various adaptations and modifications of the just-described preferred embodiments can be configured without departing from the scope and spirit of the invention. Therefore, it is to be understood that within the scope of the appended claims, the invention may be practiced other than as specifically described herein.

What is claimed is:

1. A spa audio system comprising:
a spa shell; and
a plurality of audio transducers made of a thermoplastic material attached to said spa shell for coupling sound vibration energy to said spa shell.

2. The spa audio system of claim 1 further including an amplifier located adjacent to said spa shell for supplying an audio signal to said transducers.

3. The spa audio system of claim 2 further including radio frequency transmission means for transmitting a user home audio signal to a radio frequency receiver means located adjacent to said spa shall.

4. The spa audio system of claim 1 wherein said transducers are affixed to blocks embedded in the thermoplastic material on the underside of the spa shell.

5. The spa audio system of claim 1 wherein said transducers are mounted within an enclosure.

6. The spa audio system of claim 5 wherein said enclosure has a rim attached to the spa shell.

7. The spa audio system of claim 6 wherein said rim is attached to the spa shell by an adhesive.

8. The spa audio system of claim 5 wherein said enclosure has a first cylindrical portion defining said rim at one end thereof and a second cylindrical portion wherein a circular rim of said transducer element is mounted.

9. The spa audio system of claim 8 further including means in a closed end of said enclosure for further supporting said transducer element.
